(19) United States
(12) Patent Application Publication
(10) Pub. No.: US 2026/0276025 A1
(43) Pub. Date: Sep. 17, 2026

(54) QUICK INSTALL NUT

(71) Applicant: Globe Union Industrial Corp., Taichung City (TW)

(72) Inventor: Chao-Ta Yang, Taichung City (TW)

(21) Appl. No.: 19/561,420

(22) Filed: Mar. 9, 2026

(30) Foreign Application Priority Data
Mar. 11, 2025 (CN) 202520415309.0

(51) Int. Cl. F16B 37/08

(52) U.S. Cl. CPC F16B 37/0864

(57) ABSTRACT

A quick install nut is provided. The quick install nut includes a cylindrical main body with a cylindrical slot for allowing a threaded fastener to insert through, an elastic tightening block, and a tightening ring disposed on the cylindrical main body and axially movable between an opening position and a close position. A first internal thread is disposed on the cylindrical slot and arranged opposite to an assembly groove. The elastic tightening block is mounted in the assembly groove and moved to press against the threaded fastener and further drive the cylindrical main body for engaging the first internal thread with the threaded fastener. The tightening ring includes an opening, a tightening surface, and a resisting portion. The tightening ring is moved to the closed position and abutting against an abutted portion of the elastic tightening block by the resisting portion after the tightening surface being pressed.

### FIELD OF THE INVENTION

The present invention relates to a nut, especially to a quick install nut able to be installed and operated quickly.

### BACKGROUND OF THE INVENTION

In many devices, equipment, or accessories, threaded parts with long threads including threaded rods, bolts, and threaded pipes are needed and often used in combination with nuts for threaded fastening. In many cases, the nut needs to be rotated and moved a long distance along the threaded part for fastening. This gives rise to some problems such as long time of thread engagement and low installation and operation efficiency. A limited installation and operation space goes against the rotation of the nut on the threaded part. And a force for rotating the nut is even difficult to be applied to the nut. Thus tightness of the nut on the threaded part is affected.

In order to overcome shortcomings of the conventional nut mentioned above, a quick tightening nut is provided in Pub. No. CN 206738362 U. The nut includes a nut body provided with a threaded hole and a through hole. An axis of the threaded hole is vertical while an axis of the through hole is tilted. The axis of the threaded hole and the axis of the through hole are co-planar and an angle between them is an acute angle. A part of threads in the threaded hole is removed by the design of the through hole. While in use, a threaded rod is allowed to insert through the through hole and hold in place quickly after the threaded hole being tilted. Then the nut is returned to its original position and the nut body is fastened on the threaded rod through the threaded hole. Thereby the nut is installed quickly.

However, the above design of the nut still has certain shortcomings. For example, the threaded hole is completely enclosed in the nut body so that internal threads on an inner surface of the threaded hole can't be integrally formed by demolding. The complete threaded hole and the internal threads are formed by metal processing first. Then the through hole is formed by drilling to remove a part of the internal threads is remove. Thereby manufacturing of the nut is limited by the metal processing of the internal thread and the through hole and unable to be made from plastic materials by integral molding. The production efficiency of the nut is limited and reduction of production cost including materials is unattainable due to expensive metal materials used.

The nut is designed with the through hole to avoid direct contact with external threads of the threaded rod and allow quick insert of the threaded rod through the through hole. Yet the enclosed design of the through hole limits not only the space for relief of the threaded rod, but also the tilt angle of the nut. When the nut needs to be designed into a long and thin shape, no sufficient space for relief can be provided due to the above enclosed design of the through hole. Thus the external threads of the threaded rod may be in contact with or engaged with the internal threads of the threaded hole even with the maximum tilt angle. This results in that the tilted nut is unable to move on the threaded rod smoothly and the applications of the nut are significantly limited.

### SUMMARY

Therefore, it is a primary object of the present invention to provide a quick install nut able to be installed and fastened easily, quickly, and firmly with less effort. The quick install nut is especially suitable for installation and fastening of various bathroom fixtures and accessories including faucets and toilets.

In order to achieve the above object, a quick install nut according to the present invention includes a cylindrical main body, an elastic tightening block, and a tightening ring.

The cylindrical main body is composed of an entrance end, an exit end, and a cylindrical slot formed in the cylindrical main body for allowing a threaded fastener to insert through. The cylindrical slot includes a first side and a second side located opposite to each other and disposed on the inside thereof. A first internal thread is disposed on a part of an inner peripheral wall of the cylindrical slot at the first side and an assembly groove is arranged at the inner peripheral wall of the cylindrical slot at the second side.

The elastic tightening block is mounted and positioned in the assembly groove of the cylindrical main body and provided with an abutted portion and at least one elastic deformation portion abutting against the assembly groove. The elastic tightening block is forced to move radially toward a center of the cylindrical slot and press against the threaded fastener when a force is applied to the abutted portion. The first internal thread of the cylindrical main body is further driven to move radially and engage with the threaded fastener. At the same time, the elastic deformation portion undergoes elastic deformation and produces an elastic recovery force.

The tightening ring is disposed on the entrance end of the cylindrical main body and limited to move between an open position and a closed position axially along the cylindrical main body. The tightening ring is provided with an opening, a tightening surface, and a resisting portion. The opening is corresponding to the cylindrical slot at the entrance end and allowing the threaded fastener to insert into the cylindrical slot therethrough. The tightening ring is moved axially from the open position to the closed position and further forcing the resisting portion to abut against the abutted portion of the elastic tightening block after the tightening surface being pressed. Then the first internal thread of the cylindrical main body is driven to engage with the threaded fastener.

Preferably, in the cylindrical main body of the quick install nut, a curved groove is formed on the entrance end at the second side and used for defining the assembly groove. The curved groove is provided with a notch corresponding to the center of the cylindrical slot and two positioning walls are disposed on an inner side of the curved groove and located at two lateral sides of the notch correspondingly. The elastic tightening block is further provided with a tightening portion and two elastic pieces integrally extending from two lateral sides of the tightening portion correspondingly. The tightening portion is provided with a curved tightening wall formed on an inner side thereof and attached to the external thread of the threaded fastener through the notch. The abutted portion is formed on an outer side of the tightening portion. The elastic pieces form the elastic deformation portions correspondingly for abutting against and positioned on the positioning walls.

Preferably, a second internal thread is disposed on the curved tightening wall of the quick install nut and combined with the first internal thread of the cylindrical main body to engage with the external thread of the threaded fastener tightly.

Preferably, the curved tightening wall of the quick install nut is a smooth surface for abutting and pressing against the external thread of the threaded fastener and forcing the first internal thread of the cylindrical main body to be engaged with the external thread of the threaded fastener alone.

Preferably, in the elastic tightening block of the quick install nut, the abutted portion is a slant. A resisting block is projecting from one side of the tightening ring corresponding to the cylindrical main body and the resisting portion is formed on the resisting block. The resisting portion is a slant attached to the slant of the abutted portion of the elastic tightening block.

Preferably, in the elastic tightening block of the quick install nut, the abutted portion is a slant. A resisting block is projecting from one side of the tightening ring corresponding to the cylindrical main body and the resisting portion is formed on the resisting block. The resisting portion is a partial spherical surface.

Preferably, in the cylindrical main body of the quick install nut, the entrance end of the cylindrical main body is provided with a plurality of limit locking slots and at least one action wall. The tightening ring is provided with a plurality of elastic locking hooks and at least one elastic pin. The elastic locking hooks are elastically compressed and deformed to be locked and limited in the limit locking slots so that the tightening ring is limited to move between the open position and the closed position. When the tightening ring is moved from the open position to the closed position, the elastic pin is abutting against the action wall to undergo elastic deformation and generate an elastic recovery force.

Preferably, in the tightening ring of the quick install nut, the elastic locking hooks are abutting against the limit locking slots of the cylindrical main body to undergo elastic deformation and generate an elastic recovery force when the tightening ring is moved from the open position to the closed position.

Preferably, the cylindrical main body of the quick install nut is provided with an engagement ring portion and a holding cylindrical portion extending from the engagement ring portion. The first internal thread, the assembly groove, and a part of the cylindrical slot are formed on the inside of the engagement ring portion while the rest part of the cylindrical slot is mounted on the inside of the holding cylindrical portion and a holding surface allowing users to hold and rotate is formed on the outside of the holding cylindrical portion.

Preferably, the tightening ring of the nut is in the open position under normal conditions so that the elastic tightening block is affected by positioning of the elastic deformation portions on two lateral sides thereof to be away from the center of the cylindrical slot of the cylindrical main body. During installation, the threaded fastener is allowed to be quickly inserted through a space between the first internal thread of the cylindrical main body and the curved tightening wall of the elastic tightening block or a space between the first internal thread of the cylindrical main body and the second internal thread of the elastic tightening block axially along the cylindrical main body. The nut can be fit around and moved along the threaded fastener easily and quickly until the tightening surface of the tightening ring is pressed. Then a little bit force is applied to move the tightening ring from the open position to the closed position. The elastic tightening block is also driven to move radially from the position away from the center of the cylindrical slot toward the center of the cylindrical slot and the curved tightening wall on the elastic tightening block is forced to abut against and press on the threaded fastener, or the second internal thread on the elastic tightening block is forced to engage with the external thread of the threaded fastener. At the same time, the cylindrical main body is also driven to move radially so that the first internal thread in the cylindrical slot is smoothly engaged with the external thread of the threaded fastener. Thereby the nut is threaded onto the threaded fastener. The installer only needs to rotate the nut a little bit through the holding cylindrical portion for tightening the nut and the tightening and fastening is achieved by single-hand operation easily and quickly. Therefore, the operation for fastening the nut onto the threaded fastener is easy, quick, and secure and there is no need to tilt the nut during the operation.

The integrally formed first internal thread of the cylindrical main body is used as the main engagement structure so that it is ensured that the engagement structure has sufficient strength and firmness and there is no need to arrange the second internal thread at the elastic tightening block. Only the curved tightening wall is required to provide radial abutting and pressing. Once the second internal thread is disposed on the elastic tightening block, the strength and firmness of the whole engagement structure are further improved due to the second internal thread.

Since there is no need to tilt the nut during installation, the present nut is especially suitable for installation and fastening of various bathroom fixtures and accessories including faucets and toilets. Not only time required for thread engagement of long threads is significantly shortened and ease of installation and operation is improved, reliable and durable fastening is also achieved.

Instead of an integrally-formed part, the nut is formed by the cylindrical main body, the elastic tightening block, and the tightening ring assembled with one another. The above components are respectively made of plastic materials and produced by molding. Thus the nut has advantages of easy and quick production and lightweight design.

The nut is designed to have structures able to be held and rotated conveniently by the installer such as the holding cylindrical portion and the holding surface on the holding cylindrical portion. Thereby easy holding and rotation, and operation with less effort are achieved.

### BRIEF DESCRIPTION OF THE DRAWINGS

FIG. 1 is a perspective view of an embodiment of a nut in an open position according to the present invention;

FIG. 2 is a longitudinal section along a first side and a second side of a cylindrical main body of the embodiment in FIG. 1 according to the present invention;

FIG. 3 is an exploded view of an embodiment of a nut according to the present invention;

FIG. 4 is a perspective view of a cylindrical main body of an embodiment according to the present invention;

FIG. 5 is a bottom perspective view of a tightening ring of an embodiment according to the present invention;

FIG. 6 is a perspective view of an elastic tightening block of an embodiment according to the present invention;

FIG. 7 is a longitudinal section of the embodiment in FIG. 3 in which a tightening ring is moved to a closed position according to the present invention;

FIG. 8 is a partially exploded sectional view of an embodiment applied to a first object and a second object according to the present invention;

FIG. 9 is a perspective view of another embodiment of an elastic tightening block according to the present invention;

FIG. 10 is a longitudinal section of another embodiment of a resisting portion of the tightening ring in the embodiment in FIG. 7 according to the present invention.

### DETAILED DESCRIPTION

Please refer to the following embodiments and related figures.

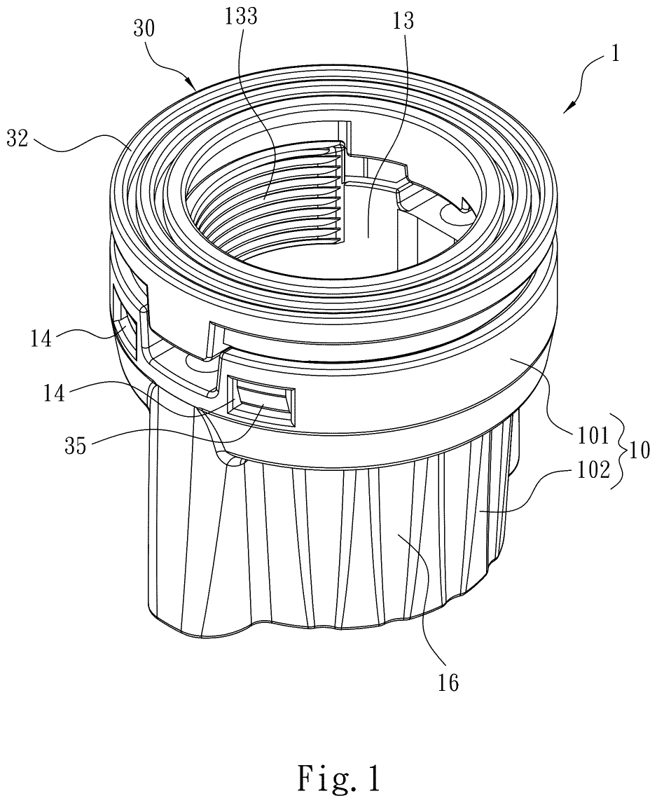

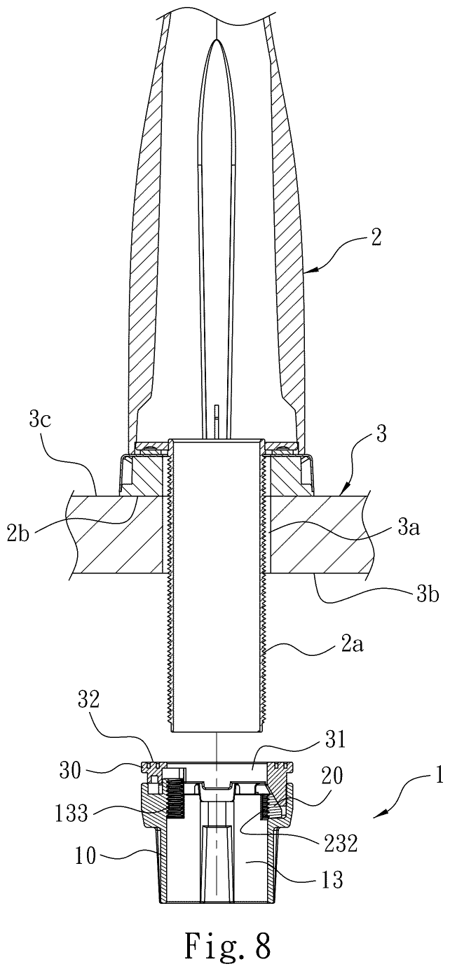

Refer to FIG. 1-7, a preferred embodiment of a quick install nut 1 is provided. The nut 1 is threaded onto a threaded fastener such as bolt, threaded rod, and threaded pipe in different forms for joining two objects or fastening the two objects on a third object quickly. As shown in FIG. 8, a first object 2 is provided with a threaded rod 2a on a bottom end. A second objects 3 is provided with at least one installation hole 3a which allows the threaded rod 2a to insert through from top to bottom. The nut 1 is quickly fit and threaded onto the threaded rod 2a and then not only abutting against a lower surface 3b of the second objects 3, but also forcing a lower surface 2b of the first object 2 to abut against and fix on an upper surface 3c of the second object 3 at the same time. Thereby the first object 2 is threaded and fastened onto the second object 3 quickly.

The first object 2 can be various faucet parts in different forms with at least one threaded rod 2a on the bottom thereof. The second object 3 is a common countertop around sink or bathtub and usually provided with at least one installation hole 3a.

In this embodiment, the nut 1 includes a cylindrical main body 10, an elastic tightening block 20, and a tightening ring 30.

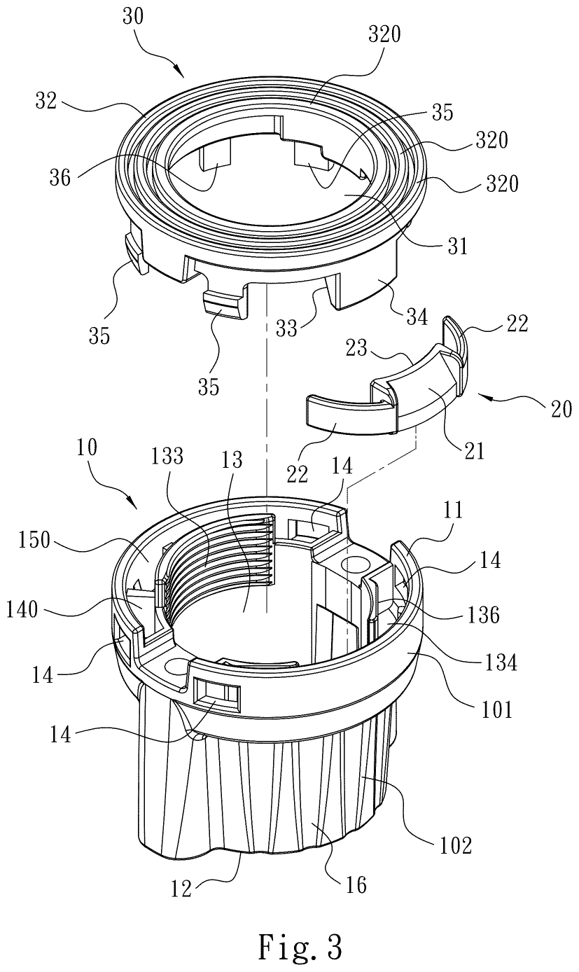

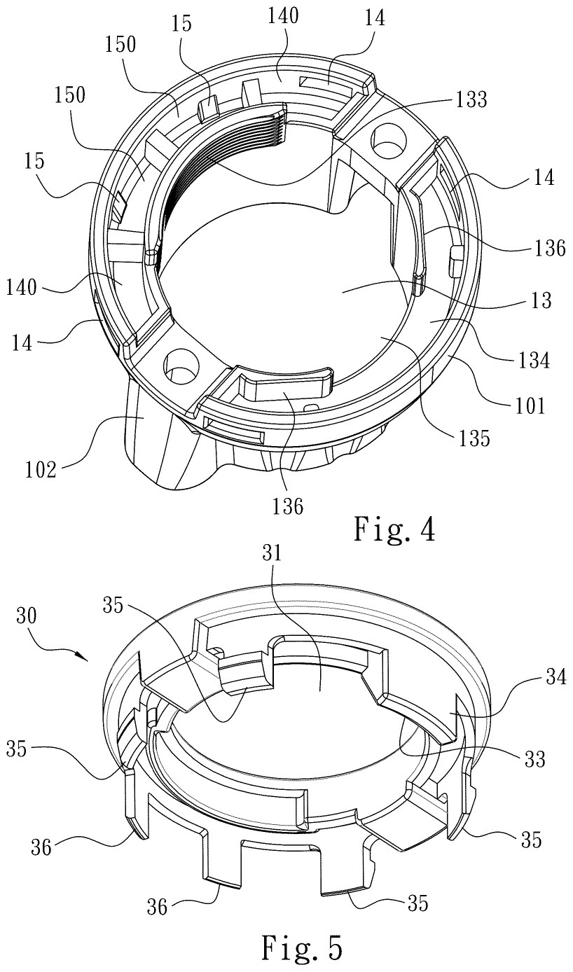

As shown in FIG. 3 and FIG. 4, the cylindrical main body 10 consists of an entrance end 11, an exit end 12, and a cylindrical slot 13 in the cylindrical main body 10 for allowing the threaded rod 2a to insert through. A first side 131 and a second side 132 opposite to the first side 131 are formed on the inside of the cylindrical slot 13. A first internal thread 133 is disposed on a part of an inner peripheral wall of the cylindrical slot 13 and located at the first side 131 while an assembly groove 134 is arranged at the inner peripheral wall of the cylindrical slot 13 and located at the second side 132.

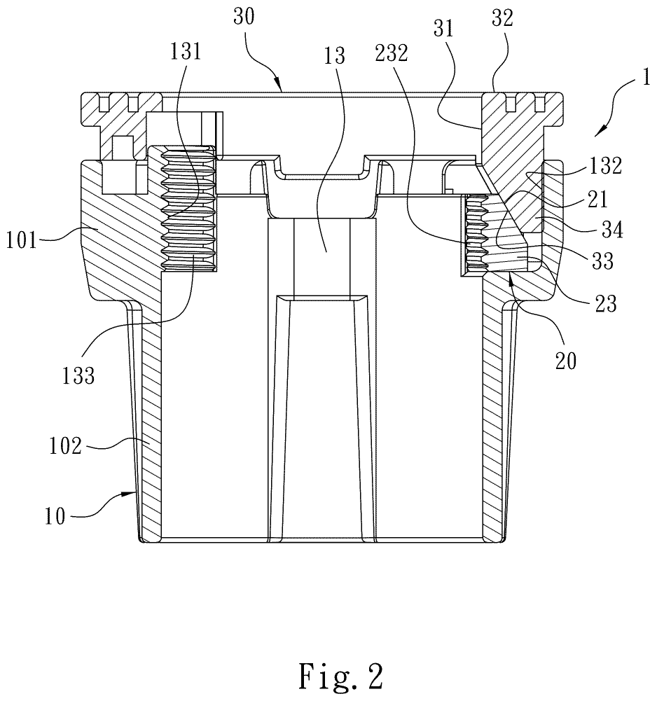

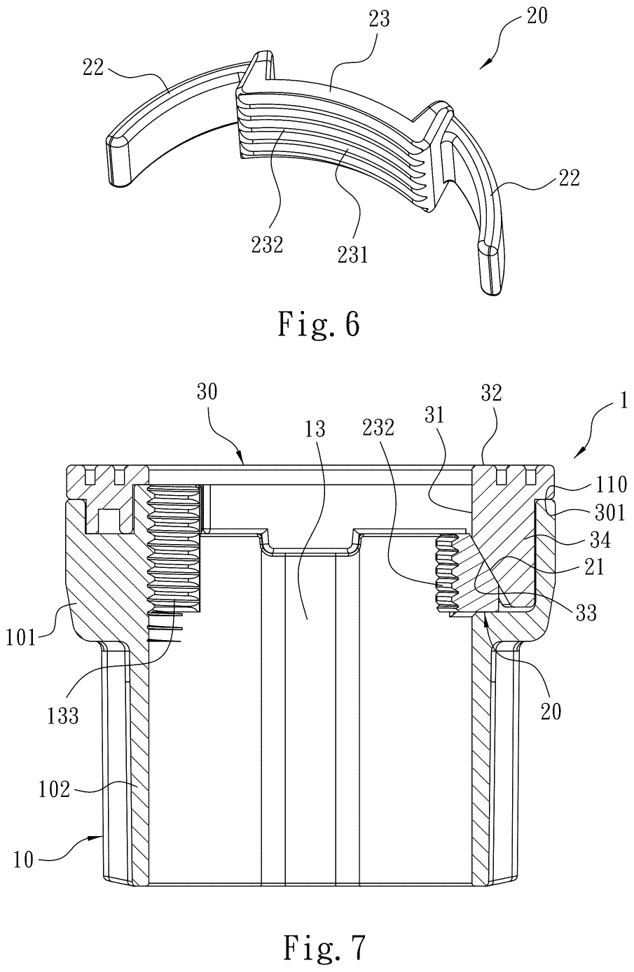

Refer to FIG. 2, FIG. 3, and FIG. 6, the elastic tightening block 20 is mounted and positioned in the assembly groove 134 of the cylindrical main body 10 and provided with an abutted portion 21 and at least one elastic deformation portion 22 abutting against a corresponding position on the assembly groove 134. When a force is applied to the abutted portion 21, the elastic tightening block 20 is forced to move radially toward a center of the cylindrical slot 13 and press against the threaded rod 2a. The first internal thread 133 of the cylindrical main body 10 is further driven to move radially and engage with an external thread of the threaded rod 2a. At the same time, the elastic deformation portion 22 undergoes elastic deformation and produces an elastic recovery force by which the elastic tightening block 20 is radially returning to its original position and thus loosened and separated from the threaded rod 2a after the force applied to the abutted portion 21 being released. Simultaneously, the first internal thread 133 of the cylindrical main body 10 is also loosened and released from the threaded rod 2a, disengaged with the threaded rod 2a.

As shown in FIG. 2, FIG. 3, and FIG. 7, the tightening ring 30 is disposed on the entrance end 11 of the cylindrical main body 10 and limited to move between an open position and a closed position axially along the cylindrical main body 10. The tightening ring 30 is composed of an opening 31, a tightening surface 32, and a resisting portion 33. The opening 31 is corresponding to the cylindrical slot 13 at the entrance end 11 and allowing the threaded rod 2a to insert into the cylindrical slot 13 therethrough. After the tightening surface 32 being pressed, the tightening ring 30 is moved axially from the open position to the closed position and the resisting portion 33 is forced to abut against the abutted portion 21 of the elastic tightening block 20. Then the first internal thread 133 of the cylindrical main body 10 is driven to engage with the external thread of the threaded rod 2a.

As shown in FIG. 3, the tightening surface 32 is formed by a plurality of annular surfaces 320 distributed radially, but not limited. The tightening surface 32 can be a complete annular surface.

Refer to FIG. 7, a bottom annular wall 301 is arranged at a bottom of the tightening ring 30. The bottom annular wall 301 of the tightening ring 30 and an upper annular edge 110 formed on top of the entrance end 11 of the cylindrical main body 10 are stopped by each other for positioning the tightening ring 30 in the closed position.

As shown in FIG. 2 and FIG. 8, it should be noted that the threaded rod 2a is allowed to be quickly inserted through the opening 31 of the tightening ring 30 and the cylindrical slot 13 of the cylindrical main body 10 when the tightening ring 30 is in the open position. During installation, the nut 1 is quickly fit around and moved along the threaded rod 2a. When the tightening surface 32 on top of the tightening ring 30 is abutting against the lower surface 3b of the second object 3, the tightening ring 30 is moved from the open position to the closed position, as shown in FIG. 7. At the moment, the elastic tightening block 20 is driven to move radially and press against the external thread of the threaded rod 2a. It is easily understood that the cylindrical main body 10 is also driven to move and the first internal thread 133 of the cylindrical main body 10 is engaged with the external thread of the threaded rod 2a. Thus an engagement is generated smoothly. Thereby installers only need to turn the nut 1 a little bit for tightening, the tightening surface 32 of the tightening ring 30 is further attached to and pressed against the lower surface 3b of the second object 3 and the first objects 2 is fastened on the second object 3 quickly and securely.

Refer to FIG. 4, in this embodiment, a curved groove is formed on the entrance end 11 of the cylindrical main body 10, located at the second side 132, and used to define the assembly groove 134. The curved groove is provided with a notch 135 corresponding to the center of the cylindrical slot 13 and two positioning walls 136 disposed on an inner side of the curved groove and located at two lateral sides of the notch 135 correspondingly. As shown in FIG. 2 and FIG. 6, the elastic tightening block 20 is further provided with a tightening portion 23 and two elastic pieces integrally extending from two lateral sides of the tightening portion 23 correspondingly. The tightening portion 23 is provided with a curved tightening wall 231 which is formed on an inner side thereof and attached to and pressed against the external thread of the threaded rod 2a through the notch 135. The abutted portion 21 is formed on an outer side of the tightening portion 23. The elastic pieces form the elastic deformation portions 22 which are abutting against and positioned on the positioning walls 136 correspondingly.

In a preferred embodiment, a second internal thread 232 is disposed on the curved tightening wall 231 and combined with the first internal thread 133 of the cylindrical main body 10 to engage with the external thread of the threaded rod 2a tightly.

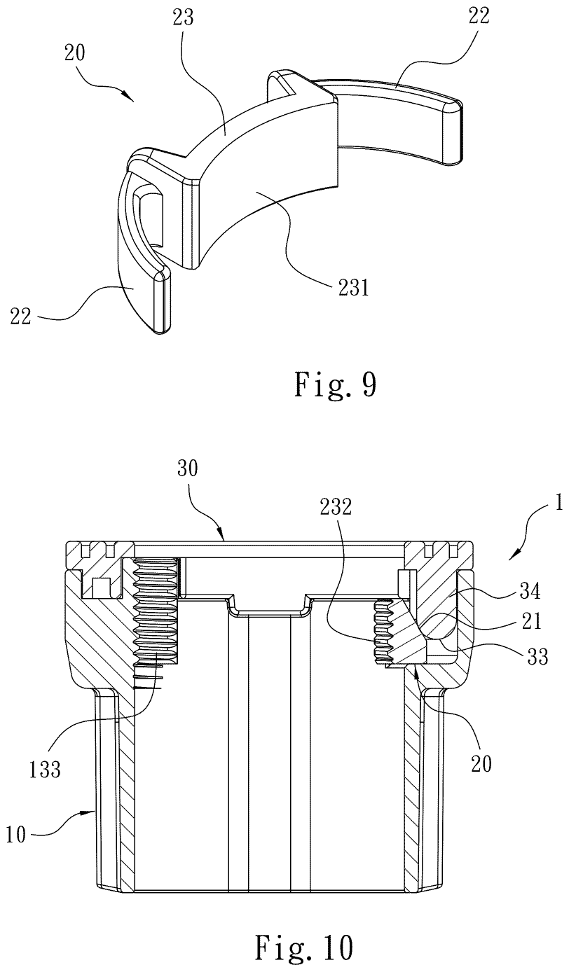

It should be noted that the main function of the elastic tightening block 20 is to apply a radial pressing tightening force to a corresponding position of the threaded rod 2a for driving the cylindrical main body 10. Thus the first internal thread 133 of the cylindrical main body 10 is moved radially and closely engaged with the external thread of the threaded rod 2a to achieve secure engagement. The engagement structure is mainly formed by the first internal thread 133 and the external thread of the threaded rod 2a. As to the elastic tightening block 20, the second internal thread 232 formed on the elastic tightening block 20 further improves the engagement. As shown in FIG. 9, there is a smooth surface formed on the curved tightening wall 231 and simply used for abutting and pressing against the threaded rod 2a. Only the first internal thread 133 of the cylindrical main body 10 is forced to be engaged with the external thread of the threaded rod 2a. The engagement required is still reached and the basic requirement is met.

In this embodiment, the abutted portion 21 of the elastic tightening block 20 is a slant. A resisting block 34 is projecting from one side of the tightening ring 30 corresponding to the cylindrical main body 10 and the resisting portion 33 is formed on the resisting block 34. The resisting portion 33 is a slant closely attached to the slant of the abutted portion 21 of the elastic tightening block 20. It is understandable that the resisting portion 33 of the resisting block 34 is not limited to the slant and able to be in other feasible shapes. For example, the resisting portion 33 is a partial spherical surface, as shown in FIG. 10.

As shown in FIG. 4 and FIG. 5, the entrance end 11 of the cylindrical main body 10 is provided with a plurality of limit locking slots 14 and at least one action wall 15. The tightening ring 30 is provided with a plurality of elastic locking hooks 35 and at least one elastic pin 36. After elastic compression and deformation, the elastic locking hooks 35 are locked and limited in the limit locking slots 14 correspondingly so that the tightening ring 30 is limited to move between the open position and the closed position. When the tightening ring 30 is moved from the open position to the closed position, the elastic pin 36 is abutting against the action wall 15 to undergo elastic deformation and generate an elastic recovery force. By the elastic recovery force of the elastic pin 36, the tightening ring 30 is automatically returning to and positioned in the open position under normal conditions from the closed position when a pressing force acted on the tightening surface 32 of the tightening ring 30 is released.

It is understandable that in a preferred embodiment, the entrance end 11 of the main body 10 is provided with a plurality of grooves and the limit locking slots 14 and the action wall 15 are arranged at an outer surface of a wall of the grooves. Refer to FIG. 3-5, in this embodiment, there are four limit locking slots 14 spaced apart from one another and four elastic locking hooks 35 corresponding to the limit locking slots 14 to ensure stable and smooth assembly and movement between the cylindrical main body 10 and the tightening ring 30. Two of the limit locking slots 14 are disposed on an outer wall of two lateral sides of the assembly groove 134 correspondingly and the rest two of the limit locking slots 14 are arranged at an outer wall of a first groove 140. In this embodiment, two action walls 15 with an interval therebetween and two elastic pins 36 corresponding to the action walls 15 are disposed on the first side 131 or one side of the main body 10 opposite to the side with the assembly groove 134. Each of the action walls 15 is formed on an outer wall of a second groove 150.

In this embodiment, the elastic locking hooks 35 are abutting against corresponding positions of the limit locking slots 14 of the main body 10 to undergo elastic deformation and generate elastic recovery force when the tightening ring 30 is moved from the open position to the closed position. The elastic recovery force of the elastic locking hook 35 is about the same as the elastic recovery force of the elastic pin 36, used to ensure the tightening ring 30 is automatically returning to and positioned in the open position under normal conditions from the closed position more smoothly when the pressing/tightening force acted on the tightening surface 32 of the tightening ring 30 is released.

In this embodiment, the cylindrical main body 10 is provided with an engagement ring portion 101 and a holding cylindrical portion 102 extending from the engagement ring portion 101. The first internal thread 133, the assembly groove 134, and a part of the cylindrical slot 13 are formed on the inside of the engagement ring portion 101 while the rest part of the cylindrical slot 13 is mounted on the inside of the holding cylindrical portion 102 and a holding surface 16 is formed on the outside of the holding cylindrical portion 102. Users can tighten or loosen the nut 1 by holding and turning the holding surface 16.

According to the above embodiment, as shown in FIG. 8, it is learned that the tightening ring 30 of the nut 1 is in the open position under normal conditions. Thus the elastic tightening block 20 is affected by positioning effect of the elastic deformation portions 22 on two lateral sides thereof to be away from the center of the cylindrical slot 13 of the cylindrical main body 10. During installation, the threaded rod 2a is allowed to be quickly inserted through a space between the first internal thread 133 of the cylindrical main body 10 and the curved tightening wall 231 of the elastic tightening block 20 or a space between the first internal thread 133 of the cylindrical main body 10 and the second internal thread 232 of the elastic tightening block 20 axially along the cylindrical main body 10. In other words, the nut 1 can be fit around and moved along the threaded rod 2a easily and quickly until the tightening surface 32 of the tightening ring 30 is in contact with and abutting against the lower surface 3b of the second object 3. Then a little bit force is applied to move the tightening ring 30 from the open position to the closed position. At the moment, the elastic tightening block 20 is driven to move radially from the position away from the center of the cylindrical slot 13 toward the center of the cylindrical slot 13 and the curved tightening wall 231 on the elastic tightening block 20 is forced to abut and press against the external thread of the threaded rod 2a, or the second internal thread 232 on the elastic tightening block 20 is forced to engage with the external thread of the threaded rod 2a tightly. At the same time, the cylindrical main body 10 is also driven to move radially so that the first internal thread 133 in the cylindrical slot 13 is smoothly engaged with the external thread of the threaded rod 2a. Thereby the whole nut 1 is threaded onto the threaded rod 2a. The installer only needs to turn the nut 1 a little bit through the holding cylindrical portion 102 by single-hand operation to achieve tightening and fastening easily and quickly and the first object 2 is smoothly fastened on the third object 3. Therefore, the fastening and the operation of the fastening the nut 1 and the threaded rod 2a are easy, quick, and secure and there is no need to tilt the nut 1 during the operation.

It is important to note that the use of the integrally formed first internal thread 133 of the cylindrical main body 10 as the main engagement structure ensures sufficient strength and firmness of the engagement structure and it is not necessary to dispose the second internal thread 232 on the elastic tightening block 20. Only the curved tightening wall 231 is required to provide radial pressing and tightening. Once the second internal thread 232 is disposed on the elastic tightening block 20, the strength and the firmness of the whole engagement structure can be further improved by the second internal thread 232.

There is no need to tilt the nut 1 during installation so that the present nut 1 is especially suitable for installation and fastening of various bathroom fixtures and accessories including faucets and toilets. Not only time required for thread engagement of long threads is significantly shortened and ease of installation and operation is improved, reliable and durable fastening is also achieved.

Instead of an integrally-formed part, the nut 1 is formed by the cylindrical main body 10, the elastic tightening block 20, and the tightening ring 30 assembled with one another. The above components are respectively made of plastic materials and produced by molding. Thus the nut 1 has advantages of easy and quick production and lightweight design.

The nut 1 is designed to have structures able to be held and rotated conveniently by the installer such as the holding cylindrical portion 102 and the holding surface 16 on the holding cylindrical portion 102. Thereby the nut 1 is easy to hold, rotate, and operate in a labor-saving manner.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A quick install nut comprising:
a cylindrical main body having an entrance end, an exit end, and a cylindrical slot formed in the cylindrical main body for allowing a threaded fastener to insert through; the cylindrical slot including a first side and a second side located opposite to each other and disposed on the inside thereof; a first internal thread disposed on a part of an inner peripheral wall of the cylindrical slot at the first side and an assembly groove arranged at the inner peripheral wall of the cylindrical slot at the second side;
an elastic tightening block mounted and positioned in the assembly groove of the cylindrical main body and provided with an abutted portion and at least one elastic deformation portion abutting against the assembly groove; while a force being applied to the abutted portion, the elastic tightening block being forced to move radially toward a center of the cylindrical slot and press against the threaded fastener; the first internal thread of the cylindrical main body further being driven to move radially and engage with the threaded fastener; the elastic deformation portion undergoing elastic deformation and generating an elastic recovery force simultaneously; and
a tightening ring disposed on the entrance end of the cylindrical main body and limited to move between an open position and a closed position axially along the cylindrical main body; the tightening ring provided with an opening, a tightening surface, and a resisting portion; the opening corresponding to the cylindrical slot at the entrance end and allowing the threaded fastener to insert into the cylindrical slot therethrough; the tightening ring moved axially from the open position to the closed position and further forcing the resisting portion to abut against the abutted portion of the elastic tightening block after the tightening surface being pressed; the first internal thread of the cylindrical main body further being driven to engage with the threaded fastener.

2. The quick install nut as claimed in claim 1, wherein a curved groove is formed on the entrance end of the cylindrical main body at the second side and used for defining the assembly groove; the curved groove includes a notch corresponding to the center of the cylindrical slot and two positioning walls disposed on an inner side of the curved groove and located at two lateral sides of the notch correspondingly; the elastic tightening block is provided with a tightening portion and two elastic pieces integrally extending from two lateral sides of the tightening portion correspondingly; the tightening portion is provided with a curved tightening wall formed on an inner side thereof and attached to and pressed against the external thread of the threaded fastener through the notch; the abutted portion is formed on an outer side of the tightening portion; the elastic pieces form the elastic deformation portions correspondingly for abutting against and positioned on the positioning walls.

3. The quick install nut as claimed in claim 2, wherein a second internal thread is disposed on the curved tightening wall and combined with the first internal thread of the cylindrical main body to engage with and clamp the external thread of the threaded fastener tightly.

4. The quick install nut as claimed in claim 2, wherein the curved tightening wall is having a smooth surface for abutting and pressing against the external thread of the threaded fastener and forcing the first internal thread of the cylindrical main body to be engaged with the external thread of the threaded fastener alone.

5. The quick install nut as claimed in claim 1, wherein the abutted portion of the elastic tightening block is a slant; a resisting block is projecting from one side of the tightening ring corresponding to the cylindrical main body and the resisting portion is formed on the resisting block; the resisting portion is a slant attached to the slant of the abutted portion of the elastic tightening block.

6. The quick install nut as claimed in claim 1, wherein the abutted portion of the elastic tightening block is a slant; a resisting block is projecting from one side of the tightening ring corresponding to the cylindrical main body and the resisting portion is formed on the resisting block; the resisting portion is a partial spherical surface.

7. The quick install nut as claimed in claim 2, wherein the entrance end of the cylindrical main body is provided with a plurality of limit locking slots and at least one action wall; the tightening ring is provided with a plurality of elastic locking hooks and at least one elastic pin; the elastic locking hooks are elastically compressed and deformed to be locked and limited in the limit locking slots so that the tightening ring is limited to move between the open position and the closed position; the elastic pin is abutting against the action wall to undergo elastic deformation and generate an elastic recovery force when the tightening ring is moved from the open position to the closed position.

8. The quick install nut as claimed in claim 7, wherein the elastic locking hooks of the tightening ring are abutting against the limit locking slots of the cylindrical main body to undergo elastic deformation and generate an elastic recovery force when the tightening ring is moved from the open position to the closed position.

9. The quick install nut as claimed in claim 1, wherein the cylindrical main body is provided with an engagement ring portion and a holding cylindrical portion extending from the engagement ring portion; the first internal thread, the assembly groove, and a part of the cylindrical slot are formed on the inside of the engagement ring portion while the rest part of the cylindrical slot is arranged at the inside of the holding cylindrical portion and a holding surface allowing users to hold and operate is formed on the outside of the holding cylindrical portion.
